(19) United States
(12) Patent Application Publication
(10) Pub. No.: US 2025/0149832 A1
(43) Pub. Date: May 8, 2025

(54) SHIELDED CONNECTOR

(71) Applicant: YAZAKI CORPORATION, Tokyo (JP)

(72) Inventors: Masaaki Iwabe, Makinohara-shi (JP); Ryo Yamashita, Makinohara-shi (JP); Masaki Ota, Makinohara-shi (JP)

(21) Appl. No.: 18/912,498

(22) Filed: Oct. 10, 2024

(30) Foreign Application Priority Data
Nov. 8, 2023 (JP) 2023-190861

(51) Int. Cl. H01R 13/6581; H01R 13/52

(52) U.S. Cl. CPC H01R 13/6581; H01R 13/5202

(57) ABSTRACT

There is provided a shielded connector including: a housing having a fitting portion to be fitted to a counterpart connector; a cover assembled to an opening opposite to the fitting portion; an annular seal member sealing a gap between the opening and the cover; a shield shell externally fitted to the housing to cover the opening; ribs disposed along an outer peripheral surface of the housing corresponding to an outside of the opening and extending along an assembling direction of the shield shell; and a holding surface projecting from an inner surface of the shield shell such that only an end of the ribs in an open end of the opening comes into contact with the holding surface to prevent the opening from being deformed in an expansion direction when the shield shell is assembled to the housing.

### CROSS-REFERENCE TO RELATED APPLICATIONS

This application is based on and claims priority under 35 USC 119 from Japanese Patent Application No. 2023-190861 filed on Nov. 8, 2023, the contents of which are incorporated herein by reference.

### TECHNICAL FIELD

The present disclosure relates to a shielded connector.

### BACKGROUND ART

In the related art, as disclosed in, for example, JP2014-086150A, JP2015-082466A, and JP2022-002194A, a shielded connector attached to a case of a device includes a housing made of synthetic resin and formed in a substantially L shape. The housing includes a fitting portion that accommodates a terminal connected to an end of an electric wire and is fitted to a device-side connector (counterpart connector), and an electric wire introduction portion into which the electric wire connected to the terminal is introduced from a direction intersecting a fitting direction of the fitting portion. The housing has a working hole (opening) on an opposite side to the fitting portion, and a cover is attached to the working hole. A metal shield shell having conductivity covers the outside of the housing.

A seal ring (annular seal member) in close contact with an inner peripheral surface (inner peripheral side seal surface) of the working hole to seal the inside of the housing is assembled to an outer peripheral side seal surface of the cover. The cover is attached to the working hole so as not to allow water or the like to enter the housing from the working hole. That is, the seal ring seals a gap between the inner peripheral side seal surface of the working hole and the outer peripheral side seal surface of the cover.

When the inner peripheral side seal surface of the working hole is creep-deformed outward by a reaction force of the seal ring under the high-temperature environment, the sealing pressure may decrease. Therefore, it is conceivable to arrange a plurality of ribs along an outer peripheral surface of the housing corresponding to the outside of the working hole to prevent creep deformation of the inner peripheral side seal surface.

However, if a rib extending along an assembling direction of the shield shell is provided at an outer periphery of the housing, the rib may be strongly brought into contact with the shield shell when the housing is assembled to the shield shell, and the force required for assembly may be increased to lower the workability.

### SUMMARY OF INVENTION

The present disclosure provides a shielded connector capable of preventing creep deformation of a housing without impairing assembly performance.

According to an illustrative aspect of the present disclosure, a shielded connector includes: a housing having a fitting portion configured to be fitted to a counterpart connector; a cover assembled to an opening opposite to the fitting portion; an annular seal member configured to seal a gap between an inner peripheral side seal surface of the opening and an outer peripheral side seal surface of the cover; a shield shell externally fitted to the housing to cover the opening; a plurality of ribs disposed along an outer peripheral surface of the housing corresponding to an outside of the opening and extending along an assembling direction of the shield shell; and a holding surface projecting from an inner surface of the shield shell such that only an end of the ribs in an open end of the opening comes into contact with the holding surface to prevent the opening from being deformed in an expansion direction when the shield shell is assembled to the housing.

According to the present disclosure, it is possible to provide a shielded connector capable of preventing creep deformation of a housing without impairing assembly performance.

The present disclosure has been briefly described above. Details of the present disclosure can be clarified by reading modes (hereinafter, referred to as “embodiments”) for carrying out the disclosure to be described below with reference to the accompanying drawings.

### BRIEF DESCRIPTION OF DRAWINGS

FIG. 1 is a perspective view of a shielded connector according to an embodiment of the present disclosure;

FIG. 2 is an exploded perspective view of the shielded connector in FIG. 1;

FIG. 3 is a perspective view illustrating an assembling procedure of the shielded connector illustrated in FIG. 2;

FIG. 4 is a front view of the shield shell in FIG. 2;

FIG. 5 is a cross-sectional view taken along a line V-V in FIG. 4;

FIG. 6 is a front view of a housing illustrated in FIG. 2;

FIG. 7 is a sectional view taken along a line VII-VII of FIG. 6;

FIG. 8 is a horizontal sectional view illustrating a state immediately before the shield shell according to the present embodiment is assembled to the housing;

FIG. 9 is a horizontal sectional view illustrating a state where the shield shell illustrated in FIG. 8 is assembled to the housing;

FIG. 10 is a horizontal sectional view illustrating a state immediately before a shield shell of a shielded connector according to a reference example is assembled to a housing; and

FIG. 11 is a horizontal sectional view illustrating a state where the shield shell illustrated in FIG. 10 is being assembled to the housing.

### DESCRIPTION OF EMBODIMENTS

Hereinafter, examples of embodiments according to the present disclosure will be described with reference to the drawings.

### Embodiment

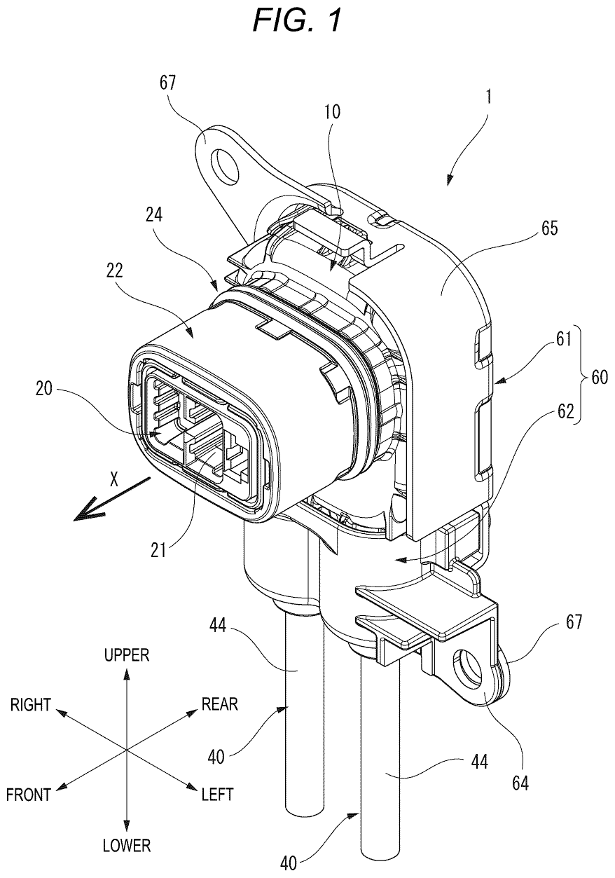

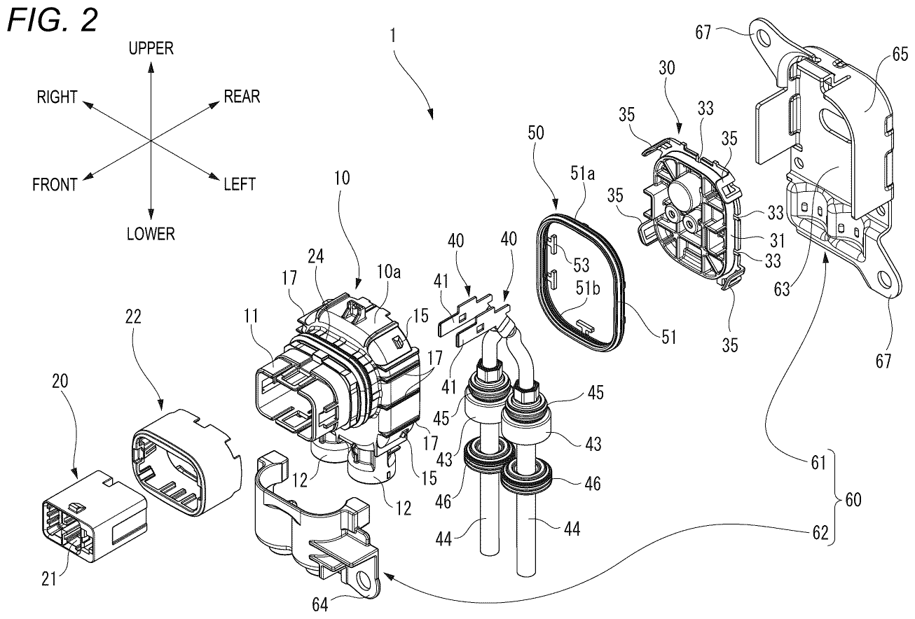

FIGS. 1 and 2 are a perspective view and an exploded perspective view of a shielded connector 1 according to an embodiment of the present disclosure.

In the present specification, a front-rear direction, an up-down direction, and a left-right direction of the shielded connector 1 follow directions of arrows in FIGS. 1 to 3. That is, the front-rear direction is a direction along a connector fitting direction of the shielded connector 1, and a side to which a not-illustrated counterpart connector is fitted is referred to as a front side of a housing 10. The up-down direction is an extension direction of a shielded electric wire 44 orthogonal to the connector fitting direction of the shielded connector 1, and a derivation direction of the shielded electric wire 44 is a downward direction. Further, the left-right direction is a longitudinal direction of a rectangular opening in a bottomed cylindrical fitting portion 11 orthogonal to the connector fitting direction.

As illustrated in FIGS. 1 and 2, the shielded connector 1 according to the present embodiment includes the housing 10, two terminal-equipped electric wires 40, a cover 30, a seal member 50, and a shield shell 60. The shielded connector 1 is, for example, a connector used in a power supply circuit such as an inverter or a motor of a vehicle such as a hybrid vehicle or an electric vehicle. The shielded connector 1 is fitted and electrically connected to a counterpart connector provided in a case such as an inverter or a motor.

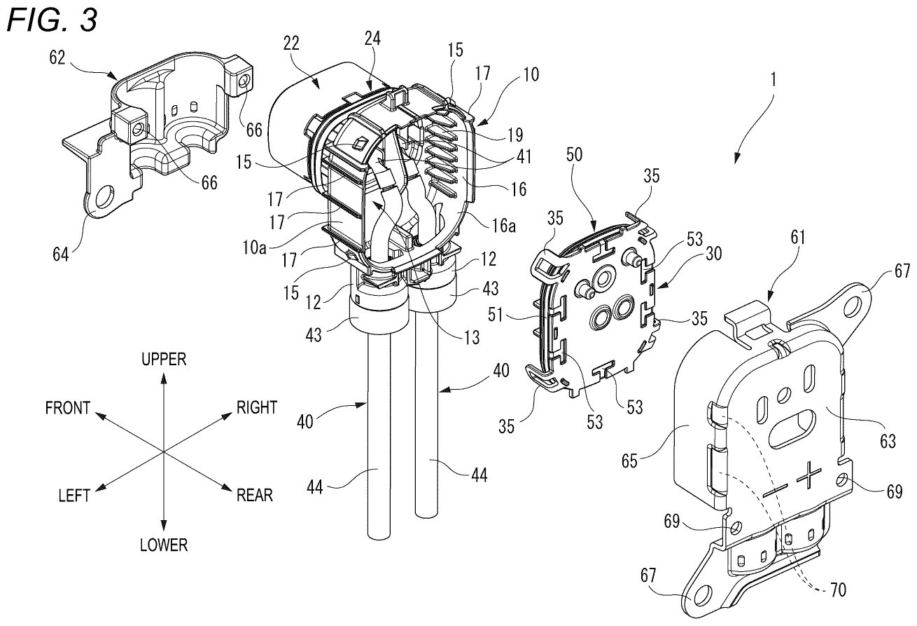

As illustrated in FIGS. 2 and 3, the housing 10 is a housing formed in a substantially L shape, and includes a fitting portion 11 that accommodates tab terminals (terminals) 41 of the terminal-equipped electric wires 40 and is fitted to a device-side connector (counterpart connector), and electric wire introduction portions 12 that are introduced from a direction in which terminals of the shielded electric wires 44 connected to the tab terminals 41 intersect with a fitting direction X (see FIG. 1) of the fitting portion 11.

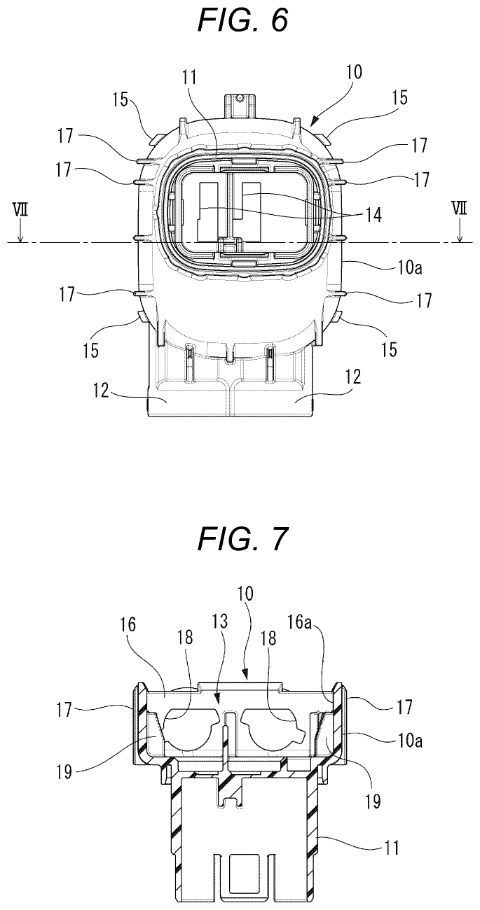

The fitting portion 11 is formed in a bottomed cylindrical shape having a rectangular opening, and protrudes forward in the fitting direction X of the housing 10 with the counterpart connector. A pair of terminal through holes 14 (see FIG. 6) is formed in a bottom portion of the fitting portion 11.

A packing 24 and a front holder 22 are assembled to an outer periphery of the fitting portion 11, and an inner housing 20 including a terminal accommodating chamber 21 is assembled to an inner periphery of the fitting portion 11.

Each electric wire introduction portion 12 extends in a downward direction that intersects with the fitting direction X of the housing 10 with the counterpart connector. Electric wire through holes 18 (see FIG. 7) through which the shielded electric wires 44 are inserted are formed in the electric wire introduction portions 12.

A rear portion of the housing 10 opposite to the fitting portion 11 is an accommodating portion 13 formed in a concave shape and opened by an opening 16. The cover 30 is assembled to the opening 16 opposite to the fitting portion 11 in the rear portion of the housing 10. The housing 10 and the cover 30 are formed of synthetic resin having electrical insulation properties. When the cover 30 is assembled to the housing 10, the opening 16, which is an attaching working hole of the terminal-equipped electric wire 40, is covered with the cover 30.

As illustrated in FIGS. 6 and 7, a plurality of ribs 17 are disposed along an outer peripheral surface 10a of the housing 10 corresponding to the outside of the opening 16. Each rib 17 is a protrusion having a rectangular cross-section extending along an assembling direction of an upper shield shell 61 to be described later. In addition, a plurality of locking claws 15 project from the outer peripheral surface 10a of the housing 10.

As illustrated in FIG. 3, a plurality of reinforcing ribs 19 are disposed at an inside corner of the accommodating portion 13 to prevent deformation of the accommodating portion 13.

As illustrated in FIGS. 2 and 3, the cover 30 is formed in a substantially rectangular plate shape and is assembled to the opening 16 of the housing 10 from a rear side via the annular seal member 50.

As illustrated in FIG. 2, the seal member 50 includes the seal body portion 51 formed in an annular shape by an elastic material such as rubber, and a plurality of T-shaped locking pieces 53 projecting toward a center from a rear end side of the seal body portion 51 in a fitting direction. Each of the T-shaped locking pieces 53 is formed in a T-shape in which a distal end portion thereof extends in the left-right direction.

An outer lip 51a is provided on an outer peripheral surface of the seal body portion 51 to be in close contact with the inner peripheral side seal surface 16a of the opening 16. An inner lip 51b is provided on an inner peripheral surface of the seal body portion 51 to be in close contact with the outer peripheral side seal surface 31 of the cover 30.

The seal member 50 is attached to the outer peripheral side seal surface 31 of the cover 30, and waterproofs and seals a gap between the opening 16 of the housing 10 and the cover 30. In the seal member 50, the T-shaped locking pieces 53 are locked to locking portion recesses 33 formed on an outer peripheral edge of the cover 30, and the movement in a fitting direction X is regulated.

Accordingly, the opening 16 of the accommodating portion 13 of the housing 10 is sealed by the cover 30 in a watertight manner. A plurality of locking pieces 35 having locking holes are formed in a peripheral edge of the cover 30. The locking claws 15 formed in the housing 10 enter the locking holes of the locking pieces 35 by assembling the cover 30 to the housing 10. The locking pieces 35 are locked by the locking claws 15, and the cover 30 is held in an assembled state with respect to the housing 10.

As illustrated in FIG. 2, each terminal-equipped electric wire 40 includes the shielded electric wire 44, the tab terminal (terminal) 41 connected to a conductor terminal of the shielded electric wire 44, a shield terminal 43 connected to a braid of the shielded electric wire 44, and rubber plugs 45 and 46 for sealing a gap between the electric wire introduction portion 12 of the housing 10 and the shielded electric wire 44.

The shielded electric wire (electric wire) 44 is configured as a coaxial cable including a core wire disposed from a center, an inner coating covering the core wire, a conductive braid covering the inner coating, and an outer sheath covering the braid.

The tab terminal 41 is formed of, for example, a conductive metal material such as copper, a copper alloy, aluminum, or an aluminum alloy. The tab terminal 41 is crimped to the core wire exposed at a terminal of the shielded electric wire 44 and is electrically connected to the shielded electric wire 44.

The tab terminal 41 is inserted into and electrically connected to an electrical connection portion of a counterpart terminal (not illustrated) provided in the counterpart connector.

In the terminal-equipped electric wire 40 assembled to the housing 10, the shielded electric wires 44 are inserted into the electric wire through holes 18 of the electric wire introduction portions 12, and the tab terminals 41 are inserted into terminal through holes 14 of the fitting portion 11 and are accommodated in the terminal accommodating chamber 21 of the inner housing 20. Thus, the tab terminals 41 of the terminal-equipped electric wires 40 are fixed to the fitting portion 11 of the housing 10.

The rubber plugs 45 and 46 are attached to the shielded electric wires 44 of the terminal-equipped electric wire 40. The rubber plug 45 seals a gap between the shield terminal 43 connected to the braid of the shielded electric wire 44 and the electric wire introduction portion 12. The rubber plug 46 seals a gap between the shielded electric wire 44 and the shield terminal 43. The rubber plugs 45 and 46 seal a gap between the shielded electric wire 44 and the electric wire introduction portion 12.

As illustrated in FIGS. 2 and 3, the shielded connector 1 according to the present embodiment includes the shield shell 60 including an upper shield shell 61 assembled from a rear side of the housing 10 and a lower shield shell 62 assembled from a lower side. The upper shield shell 61 and the lower shield shell 62 are each made of a conductive metal material.

The upper shield shell 61 is formed in a box shape having a substantially rectangular flat bottom plate portion 63 and a peripheral wall 65 erected on a peripheral edge of the bottom plate portion 63. The bottom plate portion 63 covers a rear surface of the housing 10, and the peripheral wall 65 covers an upper surface and left and right side surfaces (side surfaces) of the housing 10. The upper shield shell 61 is provided with a through hole 69 and fixing pieces 67 in which hole portions are formed.

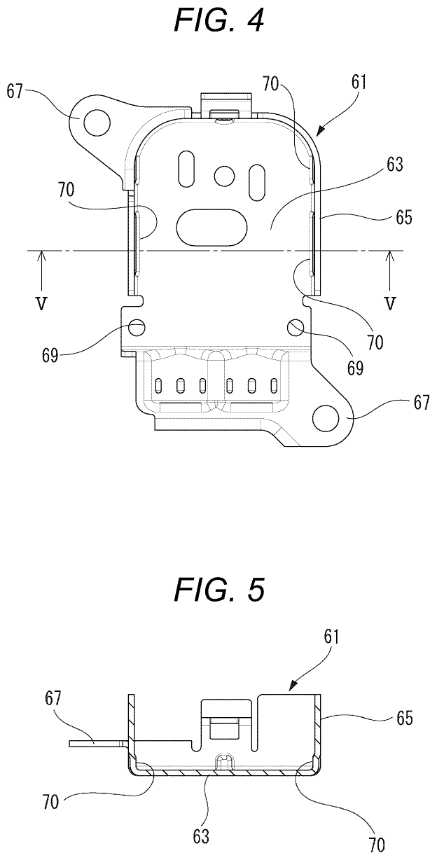

Further, as illustrated in FIGS. 4 and 5, a plurality of holding surfaces 70 project from an inner surface of the peripheral wall 65 at left and right inside corners between the bottom plate portion 63 and the peripheral wall 65 in the upper shield shell (shield shell) 61. These holding surfaces 70 can be integrally formed, for example, when the upper shield shell 61 is press-formed.

When the holding surfaces 70 are assembled to cover the rear surface of the housing 10, the holding surfaces 70 are provided to correspond to positions including the ribs 17 disposed at least line-symmetrically with respect to each other among the plurality of ribs 17 projecting from the outer peripheral surface 10a of the housing 10. In the present embodiment, the holding surfaces 70 are provided to correspond to positions of the ribs 17 disposed on left and right side surfaces along a longitudinal direction (up-down direction) of the housing 10. This is because the left and right side surfaces of the housing 10 along the longitudinal direction are more likely to creep deformation than the upper surface of the housing 10 along a short direction.

In addition, an outer dimension of the peripheral wall 65 of the upper shield shell 61 is set such that an inner surface thereof is not strongly in contact with the plurality of ribs 17 projecting from the outer peripheral surface 10a of the housing 10.

The holding surfaces 70 are provided on a back side of an inside corner of the peripheral wall 65 so that only an end of the rib 17 in an open end of the opening 16 comes into contact with the holding surfaces 70. In addition, the holding surfaces 70 are set to a protruding height such that the holding surfaces 70 can be reliably brought into contact with distal ends of the ribs 17. That is, when the upper shield shell 61 is assembled to the housing 10, the holding surfaces 70 are in contact with the distal ends of the ribs 17.

The lower shield shell (shield shell) 62 covers a portion on a front surface of the housing 10 excluding the fitting portion 11. The lower shield shell 62 is provided with screw holes 66 and fixing pieces 64 in which hole portions are formed.

Next, a case of assembling the shielded connector 1 according to the present embodiment will be described.

First, as illustrated in FIG. 3, after the shielded electric wires 44 of the terminal-equipped electric wires 40 are passed through the electric wire introduction portions 12 of the housing 10 and the tab terminals 41 are pulled out toward the accommodating portion 13, the tab terminals 41 are inserted into the terminal through holes 14 of the housing 10.

The cover 30 is brought close to the accommodating portion 13 of the housing 10 to cover the opening 16 from a rear side, and the locking claws 15 of the housing 10 are locked to the locking pieces 35 of the cover 30.

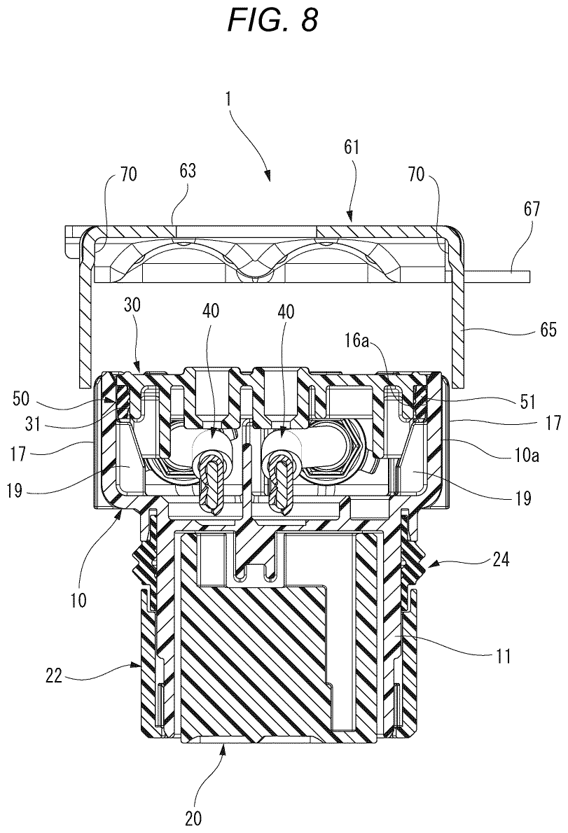

Thus, as illustrated in FIG. 8, in the seal member 50 attached such that the inner lip 51b is in close contact with the outer peripheral side seal surface 31 of the cover 30, the outer lip 51a is in close contact with the inner peripheral side seal surface 16a of the opening 16. Thus, the seal member 50 attached to the housing 10 can waterproof and seal a gap between the opening 16 of the housing 10 and the cover 30.

Next, the shield shell 60 is attached to the housing 10.

First, as illustrated in FIG. 8, the upper shield shell 61 of the shield shell 60 is attached from the rear side to cover the housing 10 to which the cover 30 is assembled.

At this time, an inner surface of the peripheral wall 65 of the housing 10 comes into sliding contact with the plurality of ribs 17 projecting from the outer peripheral surface 10a of the housing 10, but does not strongly come into contact with ribs 17. Therefore, in a state where the upper shield shell 61 is being assembled to the housing 10, there is no concern that the workability will be lowered even if the force required for assembling the upper shield shell 61 increases.

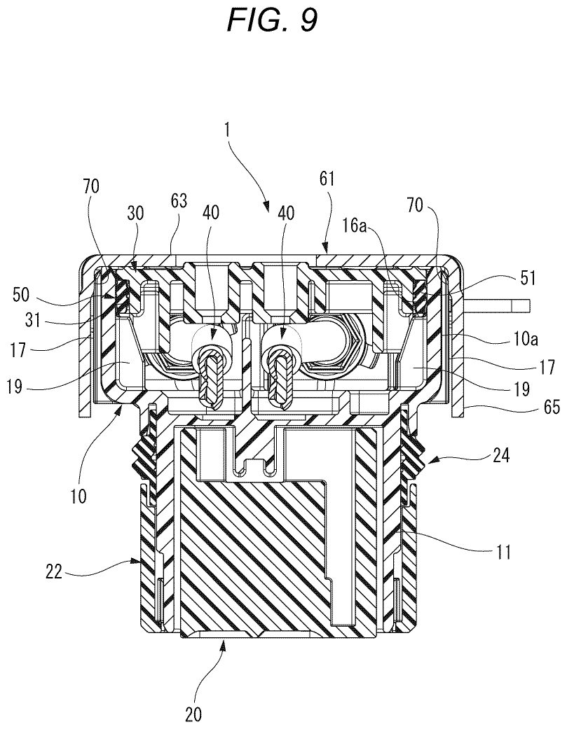

As illustrated in FIG. 9, in a state where the upper shield shell 61 is assembled to the housing 10, the holding surfaces 70 projecting from the inner surface of the peripheral wall 65 comes into contact with the ends of the ribs 17 at an open end of the opening 16, thereby preventing the deformation of the opening 16 in an expansion direction.

The lower shield shell 62 of the shield shell 60 is attached from the lower side to cover the electric wire introduction portion 12 of the housing 10.

The upper shield shell 61 and the lower shield shell 62 are attached to the housing 10, and the through holes 69 of the upper shield shell 61 and the screw holes 66 of the lower shield shell 62 communicate with each other. Thereafter, the upper shield shell 61 and the lower shield shell 62 are fixed to the housing 10 by inserting attachment screws (not illustrated) into the through holes 69 and screwing the attachment screws into the screw holes 66.

The upper shield shell 61 and the lower shield shell 62 are electrically connected to each other via the attachment screws. Further, one end of the braid of the shielded electric wires 44 is electrically connected to the shield shell 60 by the shield terminal 43 of the terminal-equipped electric wire 40.

In the shielded connector 1 having the above structure, the fitting portion 11 is fitted to a counterpart connector provided in a case such as an inverter or a motor. Accordingly, the tab terminal 41 in the fitting portion 11 is inserted into and electrically connected to the electrical connection portion of the counterpart terminal. When the shielded connector 1 is fitted to the counterpart connector, the packing 24 is brought into close contact with a housing of the counterpart connector. Thus, a fitting part between the shielded connector 1 and the counterpart connector is sealed.

When the shielded connector 1 is fitted to the counterpart connector, bolts (not illustrated) inserted into the hole portions of the fixing pieces 67 of the upper shield shell 61 and the hole portions of the fixing pieces 64 of the lower shield shell 62 are screwed into screw holes (not illustrated) formed in the case. Thus, the shielded connector 1 is pushed toward the counterpart connector by a fastening force of the bolt. Accordingly, the shielded connector 1 can be easily fitted to the counterpart connector.

Further, since the fixing pieces 67 of the upper shield shell 61 and the fixing pieces 64 of the lower shield shell 62 are fastened by bolts, the shield shell 60 is electrically connected to the case. Accordingly, the shielded connector 1 is covered with the shield shell 60 fixed to the case, and a good electromagnetic shielding effect is obtained.

When the shielded connector 1 is mounted on a vehicle, the inner peripheral side seal surface 16a of the opening 16 of the housing 10 is creep-deformed outward by a reaction force of the seal member 50 under a high-temperature environment. The holding surfaces 70 projecting from the inner surface of the peripheral wall 65 in the upper shield shell 61 comes into contact with the distal ends of the ribs 17 at the open end of the opening 16, so that deformation of the opening 16 in the expansion direction is prevented.

The shielded connector 1 according to the present embodiment can prevent the inner peripheral side seal surface 16a of the opening 16 of the housing 10 from being creep-deformed outward. As a result, it is possible to prevent a decrease in a sealing pressure of the seal member 50, and it is possible to secure a good waterproof seal.

### Reference Example

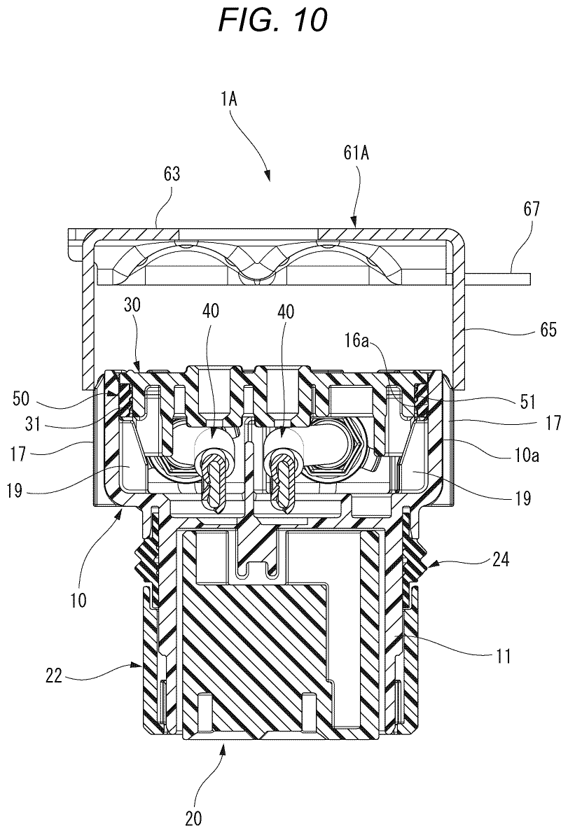

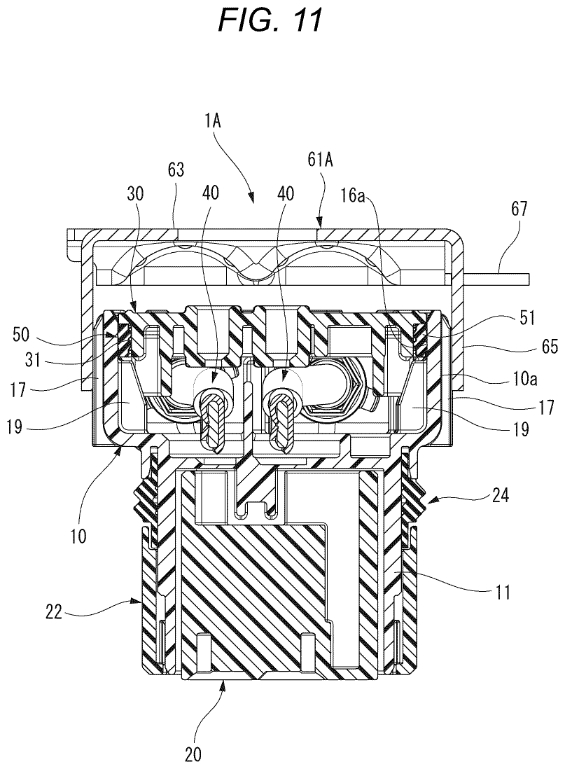

FIGS. 10 and 11 are horizontal sectional views illustrating a state immediately before an upper shield shell 61A of a shielded connector 1A according to a reference example is assembled to the housing 10 and a state during assembly.

The shielded connector 1A according to the reference example is different from that according to the above-described embodiment in a shape of the upper shield shell 61A. In the following, the same components as those in the above embodiment are denoted by the same reference numerals, and the description thereof is omitted.

In the upper shield shell 61A according to the reference example, as illustrated in FIG. 10, the holding surface 70 does not project at left and right inside corners between the bottom plate portion 63 and the peripheral wall 65.

An outer dimension of the peripheral wall 65 of the upper shield shell 61A is set such that an inner surface thereof comes into contact with the plurality of ribs 17 projecting from the outer peripheral surface 10a of the housing 10.

Therefore, in a state where the upper shield shell 61A is assembled to the housing 10, the inner surface of the peripheral wall 65 comes into contact with the ribs 17 at the open end of the opening 16, and it is possible to prevent the deformation of the opening 16 in the expansion direction.

However, as illustrated in FIG. 11, in a state where the upper shield shell 61A is being assembled to the housing 10, the inner surface of the peripheral wall 65 may come into sliding contact with the plurality of ribs 17 projecting from the outer peripheral surface 10a of the housing 10, and may be strongly brought into contact with the ribs 17.

Therefore, in the shielded connector 1A according to the reference example, the force required for assembling the upper shield shell 61A may be increased to lower the workability.

On the other hand, according to the shielded connector 1 in the present embodiment, creep deformation of the housing 10 can be prevented without impairing assembly performance.

In the shielded connector 1 according to the present embodiment, the shield shell 60 includes the upper shield shell 61 that is assembled to the housing 10 to cover the opening 16 in the rear surface of the housing 10, and the lower shield shell 62 that is assembled to the housing 10 to cover a portion on the front surface of the housing 10 excluding the fitting portion 11. The upper shield shell 61 includes a bottom plate portion 63 that covers the rear surface of the housing 10, and a peripheral wall 65 that is erected on a peripheral edge of the bottom plate portion 63 and covers the upper surface and the left and right side surfaces of the housing 10. Thus, the shielded connector 1 can obtain a good electromagnetic shield effect by a simple assembly operation.

In the shielded connector 1 according to the present embodiment, the holding surfaces 70 are formed to project from the inner surface of the peripheral wall 65 at the inside corner between the bottom plate portion 63 and the peripheral wall 65. For example, when the upper shield shell 61 is press-formed, the holding surfaces 70 can be easily formed integrally.

The present disclosure is not limited to the above-described embodiment, and can be appropriately modified, improved, or the like. In addition, materials, shapes, sizes, numbers, arrangement positions, or the like of components in the above embodiment are freely selected and are not limited as long as the present disclosure can be implemented.

For example, in the above-described embodiment, an example has been described in which the shield shell 60 including the upper shield shell 61 and the lower shield shell 62 is press-formed. The shield shell 60 may be molded by die casting or metal injection molding.

Here, features of the embodiment of the shielded connector according to the present disclosure described above are briefly summarized and listed in the following first to third aspects.

According to the first aspect, a shielded connector (1) includes: a housing (10) having a fitting portion (11) configured to be fitted to a counterpart connector; a cover (30) assembled to an opening (16) opposite to the fitting portion (11); an annular seal member (50) configured to seal a gap between an inner peripheral side seal surface (16a) of the opening (16) and an outer peripheral side seal surface (31) of the cover (30); a shield shell (60) externally fitted to the housing (10) to cover the opening (16); a plurality of ribs (17) disposed along an outer peripheral surface (10a) of the housing (10) corresponding to an outside of the opening (16) and extending along an assembling direction of the shield shell (60); and a holding surface (70) projecting from an inner surface of the shield shell (60) such that only an end of the ribs (17) in an open end of the opening (16) comes into contact with the holding surface (70) to prevent the opening (16) from being deformed in an expansion direction when the shield shell (60) is assembled to the housing (10).

According to the shielded connector (1) having a configuration of the above first aspect, the holding surface (70) projecting from the inner surface of the shield shell (60) comes into contact with a distal end of the rib (17) at an open end of the opening (16), so that the deformation of the opening (16) in an expansion direction can be prevented. Thus, under a high-temperature environment, the inner peripheral side seal surface (16a) of the housing (10) can be prevented from being creep-deformed outward.

According to the second aspect, in the shielded connector (1) according to the first aspect, the shield shell (60) includes an upper shield shell (61) that is assembled to the housing (10) to cover the opening (16) in a rear surface of the housing (10), and a lower shield shell (62) that is assembled to the housing (10) to cover a portion on a front surface of the housing (10) excluding the fitting portion (11). The upper shield shell (61) includes a bottom plate portion (63) that covers the rear surface of the housing (10), and a peripheral wall (65) that is erected on a peripheral edge of the bottom plate portion (63) and covers a side surface of the housing (10).

According to the shielded connector (1) having a configuration of the above second aspect, a good electromagnetic shield effect can be obtained by a simple assembly operation.

According to the third aspect, in the shielded connector (1) according to the second aspect, the holding surface (70) is formed to project from an inner surface of the peripheral wall (65) at an inside corner between the bottom plate portion (63) and the peripheral wall (65).

According to the shielded connector (1) having a configuration of the above third aspect, for example, when the upper shield shell (61) is press-formed, the holding surface (70) can be easily formed integrally.

What is claimed is:

1. A shielded connector comprising:
a housing having a fitting portion configured to be fitted to a counterpart connector;
a cover assembled to an opening opposite to the fitting portion;
an annular seal member configured to seal a gap between an inner peripheral side seal surface of the opening and an outer peripheral side seal surface of the cover;
a shield shell externally fitted to the housing to cover the opening;
a plurality of ribs disposed along an outer peripheral surface of the housing corresponding to an outside of the opening and extending along an assembling direction of the shield shell; and
a holding surface projecting from an inner surface of the shield shell such that only an end of the ribs in an open end of the opening comes into contact with the holding surface to prevent the opening from being deformed in an expansion direction when the shield shell is assembled to the housing.

2. The shielded connector according to claim 1, wherein
the shield shell includes an upper shield shell that is assembled to the housing to cover the opening in a rear surface of the housing, and a lower shield shell that is assembled to the housing to cover a portion on a front surface of the housing excluding the fitting portion, and
the upper shield shell includes a bottom plate portion that covers the rear surface of the housing, and a peripheral wall that is erected on a peripheral edge of the bottom plate portion and covers a side surface of the housing.

3. The shielded connector according to claim 2, wherein
the holding surface is formed to project from an inner surface of the peripheral wall at an inside corner between the bottom plate portion and the peripheral wall.
